(19) United States
(12) Patent Application Publication
(10) Pub. No.: US 2007/0170210 A1
(43) Pub. Date: Jul. 26, 2007

(54) Clamping ring and liquid product distributing device comprising such a ring

(75) Inventors: Francois Le Maner, La Vallee Montaure (FR); Jean-Marc Pardonge, Les Authieux sur Port Saint Ouen (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S

(21) Appl. No.: 10/588,716

(22) PCT Filed: Mar. 3, 2005
(86) PCT No.: PCT/FR05/50145

§ 371 Date: Aug. 8, 2006

(30) Foreign Application Priority Data
Mar. 4, 2004 (FR) 0450450

(51) Int. Cl. B65D 88/54; G01F 11/00

(52) U.S. Cl. 222/321.2; 222/321.9; 222/321.6

(57) ABSTRACT

A fastener ring (1) for fastening a dispenser member (2), such as a pump or a valve, on a neck (30) of a receptacle (3) containing fluid to be dispensed, said fastener ring (1) including deformable sealing means (10) that co-operate with said neck (30) of said receptacle (3) so as to fasten said dispenser member (2) in leaktight manner on said receptacle (3).

The present invention relates to a fastener ring for fastening a dispenser member, such as a pump or a valve, on a neck of a receptacle containing a fluid composition to be dispensed, and a fluid dispenser device including such a ring.

Fastening a dispenser member on a receptacle neck is known in the prior art, and can in particular be achieved by clamping, screw-fastening, or snap-fastening.

In those techniques, a fastener ring holding the body of a dispenser member is fastened on the neck of the receptacle, and a sealing gasket, referred to as a neck gasket, is interposed therebetween so as to guarantee sealing of the ring fastened on said neck. The presence of a gasket implies an additional component part, and complicates the manufacture and the assembly of a device.

An object of the present invention is to provide a fastener ring that does not have the above-mentioned drawbacks.

The present invention therefore proposes providing a fastener ring for fastening a dispenser member on a receptacle containing fluid to be dispensed, with the fastener ring not requiring a sealing gasket.

Another object of the present invention is to provide a dispenser device including such a fastener ring that is simpler, less costly, and easier to assemble.

Another object of the present invention is also to provide a dispenser device in which the fastener ring is snap-fastened securely on the neck of a receptacle, without any possibility of said ring being pulled off.

Still another object of the invention is to provide a fastener ring for fastening a dispenser member on a receptacle containing fluid to be dispensed, the fastener ring making it possible to compensate for and/or to accommodate any possible dimensional and/or geometrical variations or tolerances in the neck of the receptacle.

The present invention thus provides a fastener ring for fastening a dispenser member, such as a pump or a valve, on a neck of a receptacle containing fluid to be dispensed, said fastener ring including deformable sealing means that co-operate with said neck of said receptacle so as to fasten said dispenser member in leaktight manner on said receptacle.

Advantageously, said sealing means comprise at least one elastically deformable lip.

Advantageously, said sealing means comprise two deformable lips.

Advantageously, said sealing means are made integrally with said fastener ring.

Advantageously, said sealing means are injection-molded onto said fastener ring.

Advantageously, the ring includes snap-fastener means including a contact surface that is adapted to co-operate with a shoulder surface of said neck of the receptacle, so as to fasten the dispenser member on said receptacle, said contact and shoulder surfaces being substantially radial.

Advantageously, the ring is made integrally with a turret that is fastened to the dispenser member, and/or with a ferrule defining the rest position of the dispenser member.

The present invention also provides a fluid dispenser device comprising a receptacle, and a dispenser member such as a pump or a valve, the device further comprising a fastener ring as described above.

Advantageously, said sealing means of the ring fasten the dispenser member in leaktight manner on the receptacle.

Advantageously, said neck of the receptacle includes an axially-projecting portion that is suitable for co-operating with said deformable sealing means of the fastener ring.

Advantageously, said deformable sealing means of the fastener ring co-operate with said neck of the receptacle to define a leaktight-contact zone that provides the sealing, said leaktight-contact zone sloping at least in part.

Advantageously, said fastener ring makes it possible to compensate for any dimensional and/or geometrical variations in the neck of the receptacle that are linked to manufacturing tolerances.

The invention is described more fully below with reference to the accompanying drawings which show two embodiments of a fastener ring of the invention by way of non-limiting example.

In the figures:

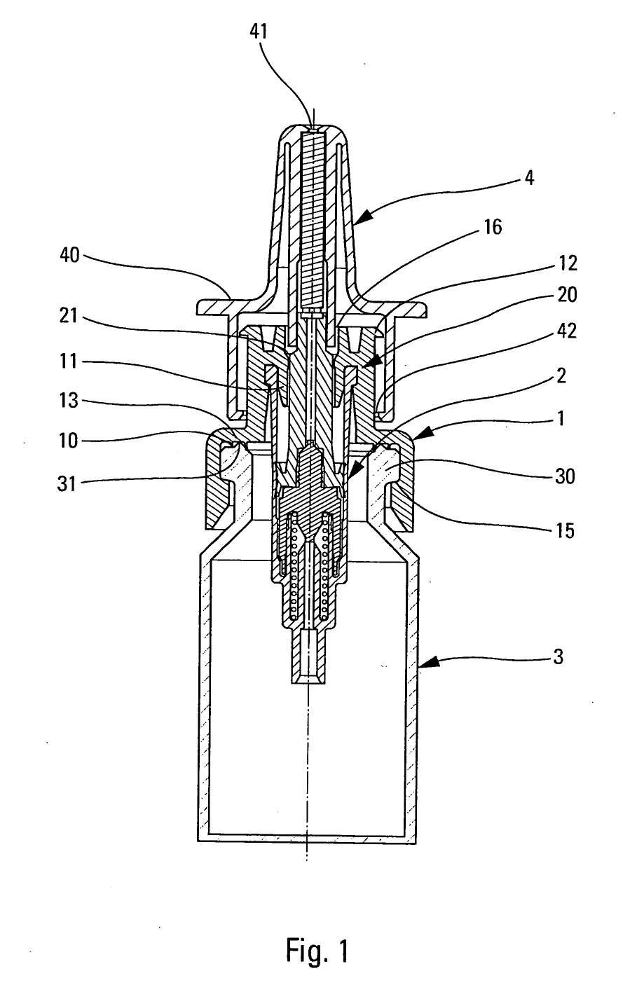

FIG. 1 is a diagrammatic longitudinal section view of a dispenser device incorporating a fastener ring constituting a first embodiment of the invention;

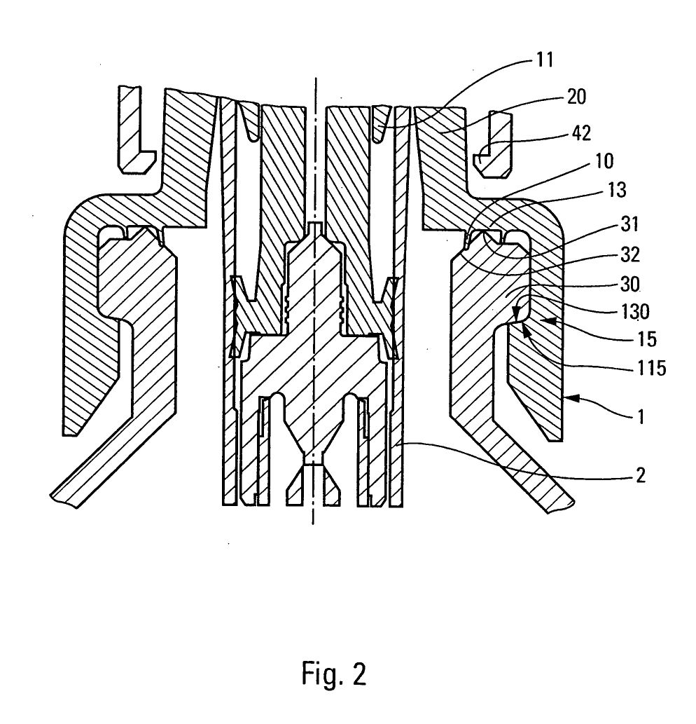

FIG. 2 is a detailed view of the fastener ring shown in FIG. 1; and

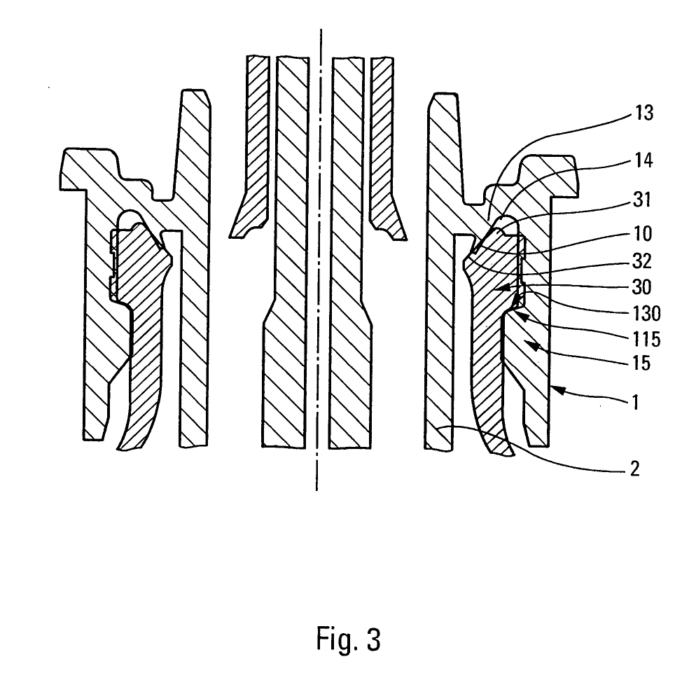

FIG. 3 is a detailed view of a fastener ring constituting a second embodiment.

With reference to FIG. 1, a fluid dispenser as shown comprises a receptacle 3, a dispenser member 2 extended by a dispenser head 4, and a fastener ring 1.

The receptacle 3 contains a fluid composition to be dispensed. The receptacle 3 presents a neck 30 defining a top edge. The structure and the function of the neck 30 are described below.

The dispenser member 2 can be of any kind, and in particular can be a pump, as shown in FIG. 1, or a valve. The pump 2 is held securely on the receptacle 3 by means of the annular fastener ring 1 that is fastened on the neck 30 of the receptacle. In particular, the pump 2 can be fastened in a turret 20, which is itself fastened on the receptacle 3 by means of the fastener ring 1. Advantageously, said turret 20 is made integrally with said ring 1. In addition, a ferrule 11 can extend into the body of the pump 2, so as to define a rest position for said pump. Advantageously, the ferrule 11 is also made integrally with said fastener ring 1.

The dispenser head 4 presents a dispenser orifice 41 through which the fluid can escape following a manual actuation exerted on a bearing zone 40. An internal shoulder 42 situated on the dispenser head 4 is advantageously provided to come into abutment with an external projection 12 formed on the turret 20, and therefore advantageously on the fastener ring 1. In the example shown in FIG. 1, the pump 2 is in its actuated position, which explains why the internal shoulder 42 is not bearing against the external projection 12. The co-operation between the internal shoulder 42 and the external projection 12 in fact avoids any possibility of the dispenser head 4 being pulled off, and this co-operation does not necessarily take place when the pump is in the rest position, but does take place when an attempt is made to pull off the head. In a variant, it is possible to imagine that the co-operation between the head and the ring is also used to define the rest position of the pump.

The fastener ring 1 is advantageously fastened by snap-fastening on the neck 30 of the receptacle 3. The fastening is provided by snap-fastener means 15 of the fastener ring 1 being positioned below the wide top edge (also referred to as the rim) defined by the neck 30 of said receptacle 3. In FIGS. 2 and 3, this snap-fastening provides the co-operation between a contact surface 115 formed on said fastener ring 1 and a corresponding shoulder surface 130 formed on said neck 30. In a preferred embodiment, the contact surface 115 projects inwards in substantially radial manner, and the shoulder surface 130 forms a corresponding external hook that is also substantially radial. Consequently, the co-operation between the contact surface 115 and the shoulder surface 130 can therefore be implemented on a plate that slopes little, or that is even completely radial. This embodiment thus guarantees that the fastener ring 1 is fastened in permanent and definitive manner on the neck 30 of the receptacle, and it generates an axial snap-fastening force that favors the sealing of the assembly.

In the invention, the fastener ring 1 includes deformable sealing means 10 that co-operate with the top edge of the neck 30. This configuration avoids the use of a sealing gasket inserted between the neck 30 of the receptacle and the fastener ring, and it is described below with reference to FIGS. 2 and 3, describing two preferred embodiments of the invention in detail. It also makes it possible to compensate for any dimensional and/or geometrical tolerances in receptacle necks, that are inherent in particular to industrial constraints in the manufacture of such receptacles.

With reference to FIGS. 2 and 3, the sealing means 10 of the ring 1 can comprise one or two deformable lips, preferably formed on a radial flange 13 of said ring 1. The small thickness of the lip(s) thus serves both to completely seal the neck of the receptacle, and to completely compensate for any dimensional and/or geometrical tolerances in the receptacle necks. The small thickness of the lips imparts particularly satisfactory deformability properties thereto, dealing fully with the problems that the present invention proposes solving.

In FIG. 2, two lips are advantageously positioned on either side of a projecting portion 31 formed on said neck 30.

For example, the projecting portion 31 can form an annular bead that comes into engagement with said sealing means 10.

The presence of two sealing lips, in particular on either side of the projecting portion, improves both sealing and compensating for any tolerances. In particular, this implementation makes it possible to make lips that are particularly thin and deformable, that not only guarantee sealing, but also adapt completely to the neck, and in particular to the projecting portion.

In general manner, the sealing means 10 form one or more annular rings that are suitable for co-operating in leaktight manner with the neck 30. In addition, it should be noted that the sealing means 10 are advantageously shaped in such a manner as to press against a beveled portion 32 of said neck 30, thereby forming a leaktight-contact zone that slopes, at least in part, relative to the radial flange 13 of the ring 1. This positioning makes it possible to establish a leaktight clamping contact between the radial flange 13 of said ring 1 and said neck 30 of the receptacle 3. The sealing means 10 can be injection-molded onto said ring 1, in which event the means 10 can be made of material that is more flexible, or they can be formed integrally with said ring 1.

In FIG. 3, a housing 14 is provided in the radial flange 13. This implementation makes it possible to increase the area of leaktight contact resulting from the co-operation between the fastener ring 1 and the neck 30, but it also favors compensating for the above-mentioned tolerances. In addition, the deformation of the housing 14 favors the disassembleability of the ring.

Various modifications can be envisaged. In particular, the sealing means 10 can be of any number and of any shape, and the top edge 30 of the neck of the receptacle 3 can also be of any shape. The snap-fastener means 15 can be continuous over the entire periphery, or they can be formed by flexible or deformable tabs.

In addition, FIG. 3 shows very diagrammatically a fastener ring 1 made integrally with a portion of the body of the pump 2, the invention also applying to circumstances in which the fastener ring is not necessarily a separate element. Naturally, the receptacle 3, the dispenser member 2, and the head 4 can be made in any way. Other modifications can also be envisaged by the person skilled in the art, without going beyond the ambit of the present invention, as defined by the accompanying claims.

1. A fastener ring (1) for fastening a dispenser member (2), such as a pump or a valve, on a neck (30) of a receptacle (3) containing fluid to be dispensed, said fastener ring (1) being characterized in that it includes deformable sealing means (10) that co-operate with said neck (30) of said receptacle (3) so as to fasten said dispenser member (2) in leaktight manner on said receptacle (3).

2. A fastener ring according to claim 1, in which said sealing means (10) comprise at least one elastically deformable lip.

3. A fastener ring according to claim 2, in which said sealing means (10) comprise two deformable lips.

4. A fastener ring according to any preceding claim, in which said sealing means (10) are made integrally with said fastener ring (1).

5. A fastener ring according to any one of claims 1 to 3, in which said sealing means (10) are injection-molded onto said fastener ring (1).

6. A fastener ring according to any preceding claim, in which the ring (1) includes snap-fastener means (15) including a contact surface (115) that is adapted to co-operate with a shoulder surface (130) of said neck (30) of the receptacle (3), so as to fasten the dispenser member (2) on said receptacle (3), said contact and shoulder surfaces (115 and 130) being substantially radial.

7. A fastener ring according to any preceding claim, in which the ring (1) is made integrally with a turret (20) that is fastened to the dispenser member (2), and/or with a ferrule (11) defining the rest position of the dispenser member (2).

8. A fluid dispenser device comprising a receptacle (3), and a dispenser member (2) such as a pump or a valve, the device being characterized in that it further comprises a fastener ring (1) according to any preceding claim.

9. A dispenser device according to claim 8, in which said sealing means (10) of the ring (1) fasten the dispenser member (2) in leaktight manner on the receptacle (3).

10. A dispenser device according to claim 8 or claim 9, in which said neck (30) of the receptacle (3) includes an axially-projecting portion (31) that is suitable for co-operating with said deformable sealing means (10) of the fastener ring (1).

11. A dispenser device according to any one of claims 8 to 10, in which said deformable sealing means (10) of the fastener ring (1) co-operate with said neck (30) of the receptacle (3) to define a leaktight-contact zone that provides the sealing, said leaktight-contact zone sloping at least in part.

12. A dispenser device according to any one of claims 8 to 11, in which said fastener ring (1) makes it possible to compensate for any dimensional and/or geometrical variations in the neck (30) of the receptacle (3) that are linked to manufacturing tolerances.
